(19) United States
(12) Patent Application Publication
(10) Pub. No.: US 2015/0019596 A1
(43) Pub. Date: Jan. 15, 2015

(54) CONTROLLER AND DATA COLLECTING METHOD

(71) Applicant: Azbil Corporation, Tokyo (JP)

(72) Inventors: Masato TANAKA, Tokyo (JP); Eisuke TOYODA, Tokyo (JP); Tomoyasu MAEDA, Tokyo (JP); Fumihiro SUGAWARA, Tokyo (JP)

(73) Assignee: AZBIL CORPORATION, Tokyo (JP)

(21) Appl. No.: 14/329,396

(22) Filed: Jul. 11, 2014

(30) Foreign Application Priority Data
Jul. 12, 2013 (JP) 2013-146230

(51) Int. Cl. G06F 17/30; G05B 23/00

(52) U.S. Cl. CPC G06F 17/30312; G05B 23/00
USPC 707/812

(57) ABSTRACT

A regulator includes an elapsed time measuring portion that measures an elapsed time after commencement of data collection, a data recording portion that records a setting value, a process variable and a manipulated variable, a data collection initiating portion that initiates the data collection when a direction of change of the setting value, when the data collection is stopped, is in a same direction as a direction of change that is a trigger for initiating the data collection, and a data collection terminating portion that terminates the data collection when the direction of change of the setting value, when data is being collected, is in the direction opposite from the direction of change that is the trigger for initiating the data collection, or when time elapsed after the commencement of data collection arrives at a time limit stored in a time limit recording portion of the regulator.

### CROSS REFERENCE TO RELATED APPLICATION

This application claims priority under 35 U.S.C. §119 to Japanese Patent Application No. 2013-146230, filed on Jul. 12, 2013, the entire content of which being hereby incorporated herein by reference.

### FIELD OF TECHNOLOGY

The present invention relates to a controller, such as a temperature controller, and, in particular, relates to a controller that is provided with a data collecting function.

### BACKGROUND

Temperature controllers that are equipped with PID controlling functions are used in order to control temperatures in heat treatment furnaces, and the like. In a temperature regulator, it is necessary to set a large number of parameters, such as PID parameters. The temperature regulator performs PID calculations using the PID parameters, to output a manipulated variable MV that will cause the measured temperature PV to go to the setting value SP that is set to the target temperature. This makes it possible to cause the measured temperature PV (the manipulated variable PV) to approach the target temperature (the setting value SP). Consequently, setting of the PID parameters, and the like, is necessary and important.

The control result information (data for characteristic values in control response, such as the time to arrival at the setting value, the amount of overshoot, and so forth) is useful information, as the result of control for the actual control target, when ascertaining states wherein there are problems in control, and when adjusting the PID parameters. Because of this, a function is executed wherein characteristic values for the control response within the temperature controller are calculated, and are stored within the temperature controller, as the series of control operations, such as heating and cooling, are performed. See, for example, Japanese Unexamined Patent Application Publication 2009-217439 (the “JP '439”). On the other hand, there are also devices, such as data loggers, that collect and record all measured data. See, for example, Japanese Unexamined Patent Application Publication 2008-286603 (the “JP '603”). The data collecting functions disclosed in these JP '439 and JP '603 enable the characteristic values for the control response in PID control, or all time series data, to be collected, to be subject to monitoring, and to be processed as subject to analysis.

However, in temperature control there are heaters, such as halogen lamps, able to increase temperatures rapidly, at more than 100° C. per second. These halogen lamps are used as rapid-heating heaters in, for example, single-wafer annealing furnaces for the front-end processes in semiconductor manufacturing processing, for example. See, for example, Japanese Unexamined Patent Application Publication 2005-260262 (the “JP '262”).

This type of rapid-heating heater requires time-synchronized checks of the respective changes in the manipulated variable MV, the measured temperature PV, the electric current in the heater, and the like. Of particular importance is regularity when dividing the data that is to be collected into individual data sets for individual heating/cooling operations when performing rapid heating/cooling at high speeds.

In measurement data collection using the data logger disclosed in the JP '603, data is collected in parallel for each of the individual devices, making it possible also to enable data collection while continuously repeating the heating and cooling operations. However, when dividing, into individual data sets, the data that is to be collected in a single heating/cooling operation, this is difficulty to achieve due to the difficulty in time synchronization.

Moreover, because of the limitation in the information that can be stored in the technology disclosed in the “JP '439, this is inadequate as a data collecting function. Moreover, when performing repetitive high-speed heating and cooling, it is necessary to handle variability in the repetitive cycling of heating and cooling, and thus there are still practical problems.

The present invention was created to solve the problems described above, and an aspect thereof is to provide a regulator and data collecting method able to secure regularity when partitioning, into individual data sets, data that is to be collected, with each individual rising/falling of a process variable when a process variable repeatedly rises and falls.

Moreover, another aspect is to provide a regulator and data collecting method able to respond to variations in cycles wherein a process variable rises and falls.

### SUMMARY

A regulator according to the present disclosure includes: a manipulated variable calculating portion that calculates and outputs, with each operating period, a manipulated variable MV based on a setting value SP and a process variable PV; a trigger recording portion that records in advance a direction of change of the setting value SP that will serve as a trigger for initiating data collection; a time limit recording portion that records in advance a time limit for terminating data collection; an elapsed time measuring portion that measures elapsed time after commencement of data collection; a data recording portion that records, with each operating period, the setting value SP, the process variable PV, and/or the manipulated variable MV, as data to be collected; a data collection initiating portion that activates the data recording portion, to start data collection when a change in a setting value SP is detected, when data collection by the data recording portion is stopped, and the direction of change in the setting value SP is in the same direction as the direction of change of the setting value SP that is recorded in the trigger recording portion; and a data collection terminating portion that terminates the data recording portion, to terminate data collection, when a change in a setting value SP is detected when data collection by the data recording portion is in progress, and the direction of change in the setting value SP is in the opposite direction from the direction of change of the setting value SP that is recorded in the trigger recording portion, or when the elapsed time after commencement of data collection has arrived at a time limit for terminating data collection, stored in the time limit recording portion.

In one example configuration of the regulator according to the present disclosure, the data recording portion records, with each operating period, an electric current value CT, in addition to the setting value SP, the process variable PV, and/or the manipulated variable MV, as data to be recorded.

Moreover, in one example configuration of the regulator according to the present disclosure, a time limit updating portion updates the time limit based on an actual elapsed time after commencement of data collection.

Moreover, in one example configuration of the regulator according to the present disclosure, when the data collection has been terminated in response to a change in the temperature setting value SP, if a value of A times the time elapsed from the commencement of data collection to the termination of data collection (where A >1) is greater than the time limit that is recorded in the time limit recording portion, then the time when the updating portion sets a value that is A times the elapsed time from the commencement of data collection to the termination of data collection as a new time limit, to update the time limit that is recorded in the time limit recording portion.

Moreover, a data collecting disclosure includes: a manipulated variable calculating step for calculating and outputting, with each operating period, a manipulated variable MV based on a setting value SP and a process variable PV; a data collection initiating step for referencing a trigger recording portion, wherein a direction of change of a setting value SP that serves as a trigger for initiating data collection is stored in advance, when a change in the setting value SP has been detected when data collection is stopped, and for activating a data recording portion, to initiate data collection, if the direction of change of the setting value SP is the same as the direction of change of the setting value SP that is stored in the trigger recording portion; a data recording step for recording by the data recording portion, with each operating period, the setting value SP, the process variable PV, and/or the manipulated variable MV, as data to be collected; an elapsed time measuring step for measuring elapsed time after commencement of data collection; and a data collection terminating step for terminating the data recording portion, to terminate data collection, when a change in a setting value SP is detected when data collection by the data recording portion is in progress, and the direction of change in the setting value SP is in the opposite direction from the direction of change of the setting value SP that is recorded in the trigger recording portion, or when the elapsed time after commencement of data collection has arrived at a time limit for terminating data collection, stored in the time limit recording portion.

The present invention makes it possible to secure orderliness when dividing, into individual data sets for each single rising/falling motion of the process variable PV, the data that is to be collected when the process variable PV rises and falls repetitively. In the present invention, even if the rising/falling cycle of the process variable PV is produced over a time interval that is shorter than the time limit for terminating the data collection, the data collection is terminated in response to a change in the setting value SP, so there is no loss of the partitioning of the data set. Moreover, in the present invention, not only is the data collection completed in response to a change in the setting value SP, but also the data collection is terminated by the elapsed time after commencement of the data collection, so that even if a state continues wherein no change occurs in the setting value SP, the data collection can still be terminated appropriately. Moreover, in the present invention, the data collection termination evaluating function can be a simple evaluating function, and thus can be provided at a low cost.

Moreover, the present invention makes it possible to perform operations appropriately even when it is not possible to ascertain clearly in advance the variability in the repetitive rising/falling cycles of the process variable PV, through the provision of a time limit updating portion that updates a time limit based on actual results of elapsed time after the commencement of data collection.

### BRIEF DESCRIPTIONS OF THE DRAWINGS

FIG. 1 is a block diagram illustrating a structure of a controller according to Example according to the present disclosure.

FIG. 2 is a flowchart illustrating the operation of the controller according to the Example according to the present disclosure.

FIG. 3 is a diagram for explaining the operation of the controller according to the Example according to the present disclosure.

FIG. 4 is a block diagram illustrating a structure of a controller according to Another Example according to the present disclosure.

FIG. 5 is a flowchart illustrating the operation of the controller according to the Another Example according to the present disclosure.

### DETAILED DESCRIPTION

In the present invention, as an example of data that is collected there is a setting value SP, a process variable PV, a manipulated variable MV, and an electric current value CT in a heater. The manipulated variable MV is calculated within the regulator based on the setting value SP, which is set in the regulator (which is, for example, a temperature regulator), and a process variable PV that is inputted from a measurement instrument (a sensor) that is connected to the regulator. The electric current value CT is inputted into the regulator in order to detect a burnt-out heater. That is, the setting value SP, the process variable PV, the manipulated variable MV, and the electric current value CT are all collected by the regulator, and are used by the hardware.

Changes in the process variable PV and the manipulated variable MV are triggered by changes in the setting value SP. Consequently, for a heating operation, a change in the setting value SP in the direction of increased temperature, when data collection is stopped, should be the trigger for initiating data collection. For a cooling operation, a change in the setting value SP in the direction of decreased temperature, when data collection is stopped, should be the trigger for initiating data collection. Even if the change in the setting value SP is a ramped change, the trigger and the change of setting in the same direction are continued. Consequently, if the change in the setting value SP, that is the trigger for initiating data collection, is a change in the setting value SP in the same direction, then the data collection should be continued. In the case of repetitively increasing and decreasing the temperature, a change in the setting value SP in the cooling direction, that is, in the opposite direction from the change in the setting value SP in the heating direction, which has been the trigger for initiating data collection, should stop the data collection.

Doing this causes the times required from the point in time of the commencement of data collection until the beginning of the actual change in the process variable PV and the manipulated variable MV to be identical, for regularity, thus making it possible to reliably partition the data into individual data sets corresponding to single heating/cooling operations. Moreover, even if there are variations in the repetitive cycles of heating/cooling, still there will be no problems. However, because it is also necessary to consider situations wherein, during data collection, a state wherein the setting value SP is maintained at a constant value continues over an extended period of time, it is necessary to also use, in parallel, data collection termination based on data collection time limits.

While the data collection time limit may be set in advance, preferably the time limit is determined automatically based on actual results of the elapsed time from the commencement of data collection through the termination of data collection, wherein the time of the commencement of data collection and the time of the termination of data collection through a change in the setting value SP in the opposite direction are measured, based on the assumption that there will be variability in the repeated cycles of heating/cooling. For example, a value that is between 1.5 and 2 times the elapsed time from the commencement of data collection until the termination of data collection may be set as the new time limit.

### EXAMPLE

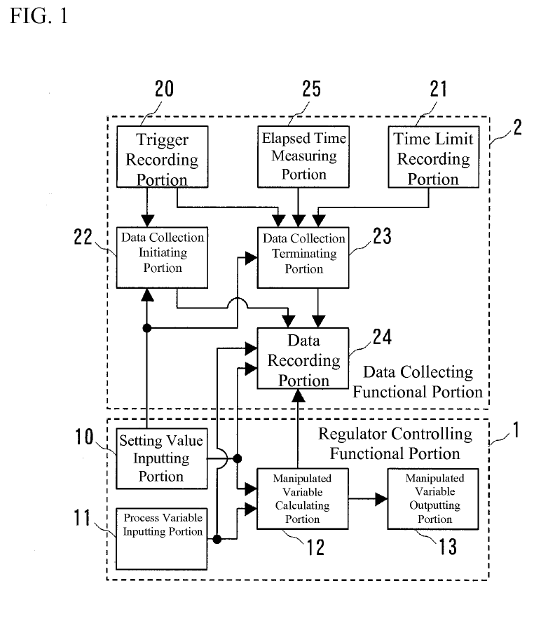

Forms for carrying out the present disclosure will be explained below in reference to the figures. FIG. 1 is a block diagram illustrating a structure for a controller according to Example according to the present disclosure. A regulator controlling functional portion 1, which is a typical structure that is conventionally provided in a regulator, and a data collecting functional portion 2, which is a distinctive structure in the present example, are provided.

The regulator controlling functional portion 1 is provided with: a setting value inputting portion 10 for inputting a setting value SP from outside of the regulator; a process variable inputting portion 11 for inputting a process variable PV from a measurement instrument; a manipulated variable calculating portion 12 for calculating a manipulated variable MV based on the setting value SP and the process variable PV; and a manipulated variable outputting portion 13 for outputting the manipulated variable MV to outside of the regulator.

The data collecting functional portion 2 is provided with: a trigger recording portion 20 for storing, in advance, a direction of change in the setting value SP that will serve as a trigger for starting the data collection; a time limit recording portion 21 for storing, in advance, a time limit for data collection termination; a data collection initiating portion 22 for evaluating the data collection start time and for initiating the data collection; a data collection terminating portion 23 for evaluating the data collection termination and for stopping the data collection; a data recording portion 24 for recording, for each operating period, at least one data that is to be collected, from among a setting value SP, a process variable PV, and a manipulated variable MV; and a elapsed time measuring portion 25.

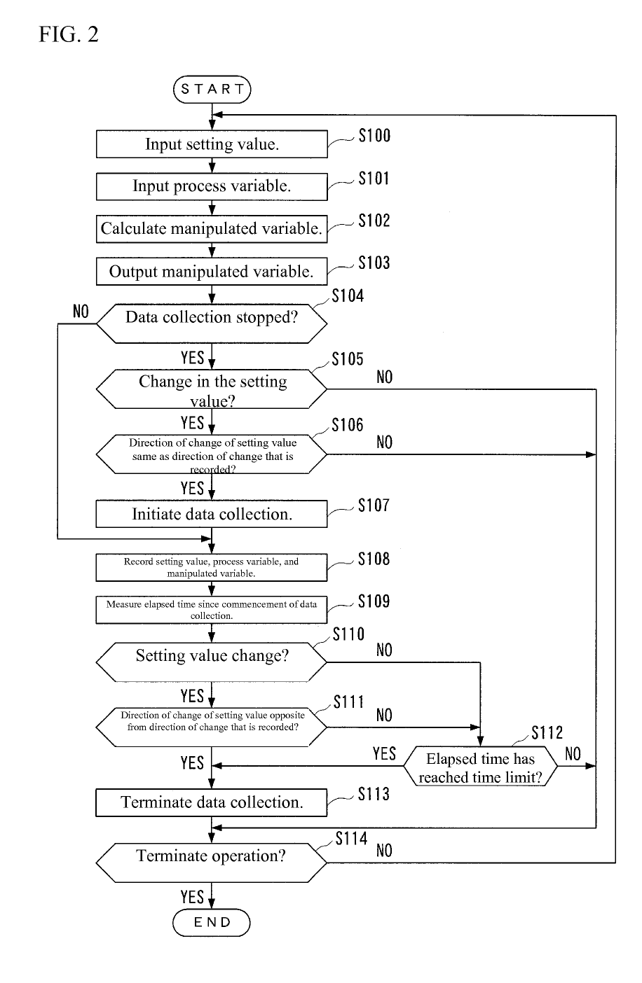

The operation of the regulator according to the present example will be explained next in reference to FIG. 2. The setting value SP is set by an operator, or the like, and is inputted into the manipulated variable calculating portion 12 through the setting value inputting portion 10 (FIG. 2, Step S100).

The process variable PV is measured by a measurement instrument, not shown, and inputted into the manipulated variable calculating portion 12 through the process variable inputting portion 11 (FIG. 2, Step S101).

The manipulated variable calculating portion 12 calculates the manipulated variable MV in accordance with a known control calculating algorithm so that the process variable PV will match the setting value SP (FIG. 2, Step S102). The control calculating algorithm is, for example, a PID.

The manipulated variable outputting portion 13 outputs, to the controlled subject, the manipulated variable MV that has been calculated by the manipulated variable calculating portion 12 (FIG. 2, Step S103). When the control target is, for example, a heat treatment furnace, a power regulator for supplying electric power to the heater in the heat treatment furnace is the actual destination to which the manipulated variable MV will be outputted.

If, when the data collection by the data recording portion 24 is terminated (FIG. 2, Step S104: YES), the data collection initiating portion 22 detects a change in the setting value SP that is inputted from the setting value inputting portion 10 (FIG. 2, Step S105: YES), and the direction of change of the setting value SP is in the same direction as the direction of change of the setting value SP that has been recorded in advance in the trigger recording portion 20 (FIG. 2, Step S106: YES), then the data recording portion 24 is activated, and data collection is started (FIG. 2, Step S107). The data collection initiating portion 22 evaluates that there has been a change in a setting value SP when a setting value SP that has been inputted from the setting value inputting portion 10 is different from the setting value SP from the immediately previous operating period.

For example, if data is collected and recorded during a heating operation, then the “rising direction” may be recorded in the trigger recording portion 20 as the direction of change of the setting value SP to serve as the trigger for initiating data collection. As a result, data collection will start when the setting value SP has been changed in the upward direction. Moreover, if data is collected and recorded during a cooling operation, then the “falling direction” may be recorded in the trigger recording portion 20 as the direction of change of the setting value SP to serve as the trigger for initiating data collection.

Following this, the data recording portion 24 that has been activated records the setting value SP that has been inputted from the setting value inputting portion 10, the process variable PV that is inputted from the process variable inputting portion 11, and the manipulated variable MV that is calculated by the manipulated variable calculating portion 12 (FIG. 2, Step S108).

The elapsed time measuring portion 25 measures the amount of time that has elapsed after the commencement of data collection (FIG. 2, Step S109).

If, when the data collection by the data recording portion 24 is in process, the data collection terminating portion 23 detects a change in the setting value SP that is inputted from the setting value inputting portion 10 (FIG. 2, Step S110: YES), and the direction of change of the setting value SP is in the same direction as the direction of change of the setting value SP that has been recorded in advance in the trigger recording portion 20 (FIG. 2, Step S111: YES), or the elapsed time after commencement of data collection has arrived at a time limit for terminating data collection, stored in the time limit recording portion 21 (FIG. 2, Step S112: YES), then the data recording portion 24 is stopped, and data collection is terminated (FIG. 2, Step S113).

The processes in Step S100 through S113 as described above are repeated at each control interval until the control is terminated through, for example, an instruction from an operator (YES in Step S114 in FIG. 2).

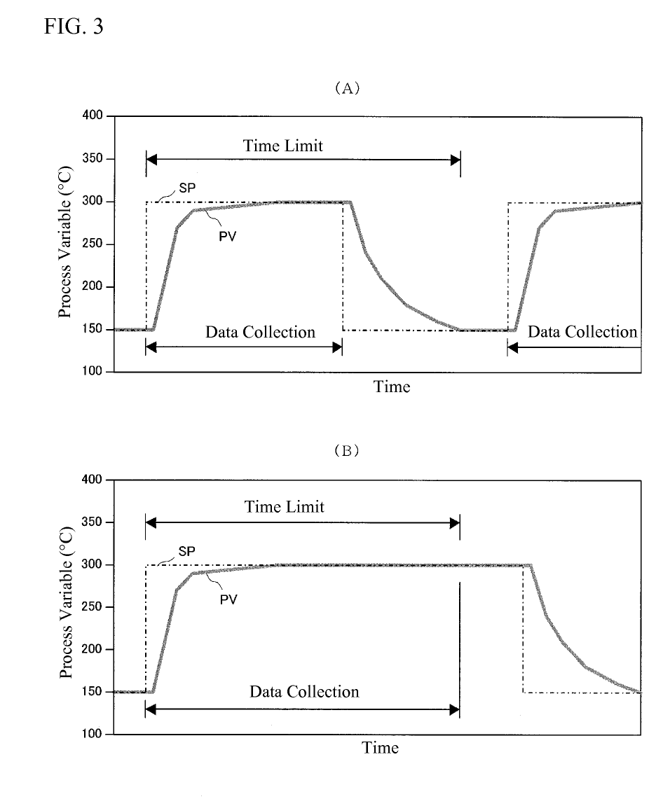

FIG. 3 (A) and FIG. 3 (B) are diagrams for explaining the operation of the regulator according to the present example, where FIG. 3 (A) illustrates a case wherein the data collection is terminated by a change in the setting value SP, and FIG. 3 (B) illustrates a case wherein the data collection is terminated through a time limit. The horizontal axes in FIG. 3 (A) and FIG. 3 (B) represent time, and the vertical axes represent the process variable PV. Here the explanation will assume that the setting value SP is a temperature setting value, and the process variable PV is a temperature measurement, in a case such as, for example, collecting data during a heating operation in a heat treatment furnace.

In the example in FIG. 3 (A), data collection commences at the point in time wherein the setting value SP is changed from 150° C. to 300° C., and data collection is terminated when the setting value SP is changed from 300° C. to 150° C. Thereafter, data collection is performed each time similar heating/cooling operations are performed.

In the example in FIG. 3 (B), data collection is terminated because, after the commencement of data collection as in FIG. 3 (A), and prior to the change in the setting value SP from 300° C. to 150° C., the elapsed time after the commencement of data collection reaches the time limit for data collection termination.

As set forth above, present example makes it possible to secure orderliness when dividing, into individual data sets for each single rising/falling motion of the process variable PV, the data that is to be collected when the process variable PV rises and falls repetitively. This regularity, specifically, proper regularity so that the beginning of the data set is at the point in time of a change in the setting value SP, causes proper regulation of a change in the manipulated variable MV or a process variable PV as the timing of the start of a control operation.

In the present example, even if the rising/falling cycle of the process variable PV is produced over a time interval that is shorter than the time limit for terminating the data collection, the data collection is terminated in response to a change in the setting value SP, so there is no loss of the partitioning of the data set. Moreover, using, as a terminating condition for data collection other than the time limit, a direction of change of the setting value SP in the opposite direction of the direction of change of the setting value SP that has been recorded in the trigger recording portion 20 enables the data collection termination evaluating function to be a simple evaluating function.

Moreover, in the present example, not only is the data collection completed in response to a change in the setting value SP, but also the data collection is terminated by the elapsed time after commencement of the data collection, so that even if a state continues wherein no change occurs in the setting value SP, due to some reason such as a malfunction, the data collection can still be terminated appropriately. That is, there will be no loss of data set partitioning.

Note that while in the present example three types of data, specifically the setting value SP, the process variable PV, and the manipulated variable MV were collected, there is no limitation thereto, but instead the system may be such that only one of these three is collected.

### Another Example

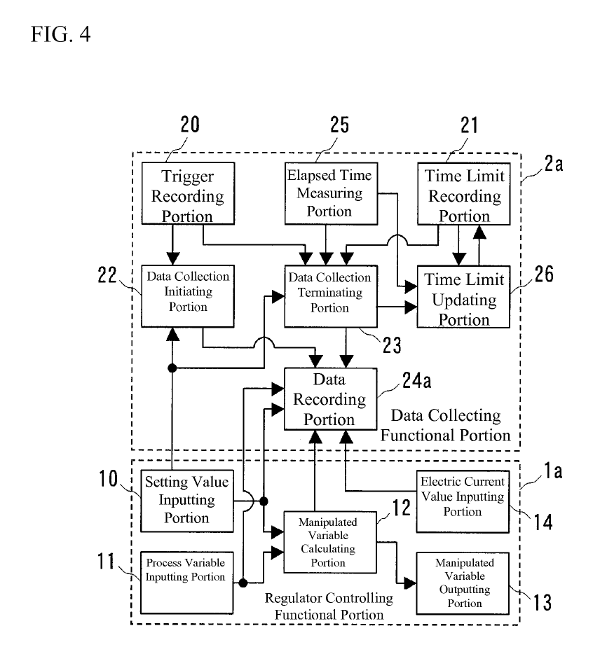

Another Example according to the present disclosure will be explained next. FIG. 4 is a block diagram illustrating a structure of a controller according to the Another Example according to the present disclosure, where structures identical to those of FIG. 1 are assigned identical codes. The regulator according to the present example is provided with a regulator controlling functional portion 1a and a data collecting functional portion 2a.

The regulator controlling functional portion 1a includes a setting value inputting portion 10, a process variable inputting portion 11, a manipulated variable calculating portion 12, a manipulated variable outputting portion 13, and an electric current value inputting portion 14 for inputting an electric current value CT for the electric current that flows in the halogen lamp (a high-speed heater).

The data collecting functional portion 2a includes a trigger recording portion 20, a time limit recording portion 21, a data collection initiating portion 22, a data collection terminating portion 23, a data recording portion 24a for recording, with each operating period, the electric current value CT, in addition to the setting value SP, the process variable PV, and the manipulated variable MV, as data to be collected, an elapsed time measuring portion 25, and a time limit updating portion 26 for updating a time limit for terminating the data collection based on the actual elapsed time after the commencement of data collection.

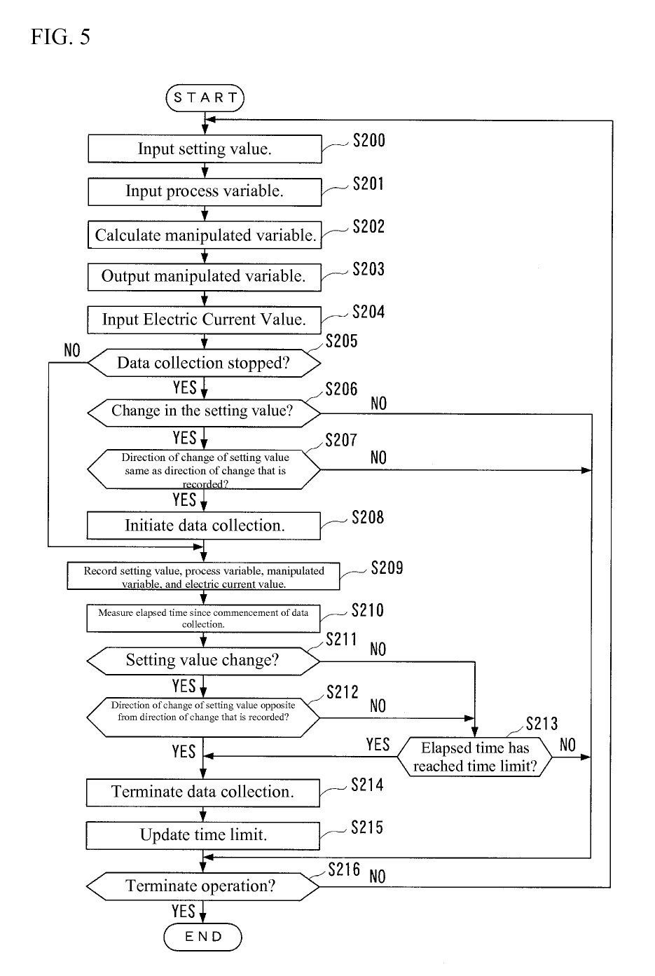

The operation of the regulator according to the present example will be explained next in reference to FIG. 5. The procedures in Step S200 through S203 in FIG. 5 are identical to the respective Step S100 through S103 in FIG. 2, so explanations thereof will be omitted. In the present example, the control target is a heat treatment furnace that is provided with a halogen lamp (a high-speed heater), so the actual output destination for the manipulated variable MV is the electric power regulator for supplying electric power to the halogen lamp. In this case, the setting value SP is a temperature setting value, and the process variable PV is a measured temperature that is measured by an instrument (sensor) of the heat treatment furnace.

The electric current value inputting portion 14 acquires an electric current value CT from an electric current value measuring portion (not shown) that measures the value CT of the electric current that flows in the halogen lamp (the high-speed heater) (FIG. 5, Step S204).

If, when the data collection by the data recording portion 24a is terminated (FIG. 5, Step S205: YES), the data collection initiating portion 22 detects a change in the setting value SP that is inputted from the setting value inputting portion 10 (FIG. 5, Step S206: YES), and the direction of change of the setting value SP is in the same direction as the direction of change of the setting value SP that has been recorded in advance in the trigger recording portion 20 (FIG. 5, Step S207: YES), then the data recording portion 24a is activated, and data collection is started (FIG. 5, Step S208).

In the present example, if data is collected and recorded during a heating operation in a heat treatment furnace, then the “rising direction” (the heating direction) is recorded in advance in the trigger recording portion 20 as the direction of change of the setting value SP to serve as the trigger for initiating data collection. As a result, data collection will start when the setting value SP has been changed in the upward direction.

Following this, the data recording portion 24a that has been activated records the setting value SP (the temperature setting value) that has been inputted from the setting value inputting portion 10, the process variable PV (the measured temperature) that is inputted from the process variable inputting portion 11, the manipulated variable MV (the heater manipulated variable) that is calculated by the manipulated variable calculating portion 12, and the electric current value CT that is inputted from the electric current value inputting portion 14 (FIG. 5, Step S209).

The elapsed time measuring portion 25 measures the amount of time that has elapsed after the commencement of data collection (FIG. 5, Step S210).

If, when the data collection by the data recording portion 24a is in process, the data collection terminating portion 23 detects a change in the setting value SP that is inputted from the setting value inputting portion 10 (FIG. 5, Step S211: YES), and the direction of change of the setting value SP is in the same direction as the direction of change of the setting value SP that has been recorded in advance in the trigger recording portion 20 (FIG. 5, Step S212: YES), or the elapsed time after commencement of data collection has arrived at a time limit for terminating data collection, stored in the time limit recording portion 21 (FIG. 5, Step S213: YES), then the data recording portion 24a is stopped, and data collection is terminated (FIG. 5, Step S214). In the example in the present example, data collection will be terminated when the setting value SP has been changed in the downward direction.

When the data collection has been terminated in response to a change in the temperature setting value SP, if the value of A times the time elapsed from the commencement of data collection to the termination of data collection (where A >1, for example, A=1.5-2.0) is greater than the time limit that is recorded in the time limit recording portion 21, then the time limit updating portion 26 sets the value that is A times the elapsed time from the commencement of data collection to the termination of data collection as a new time limit, to update the time limit that is recorded in the time limit recording portion 21 (FIG. 5, Step S215).

The processes in Step S200 through S215 as described above are repeated at each operating period until the operation is terminated through, for example, an instruction from an operator (FIG. 5, Step S216: YES).

In this way, in the present example, the time limit for terminating data collection is set automatically referencing the actual data collection time that is based on the direction of change of the temperature setting value SP, making it possible to operate properly even without ascertaining clearly in advance the variability in the repetitive cycles of the process variable PV moving upward and downward.

Although the electric current value CT is a state variable that is particularly difficult to synchronize to time and that changes rapidly, in terms of data quality, synchronization of timing with the control operations (the measured temperature PV and the heater manipulated variable MV) is of paramount importance, and so preferably data collection is integrated with the regulator function.

Note that the controllers explained in the Example and the Another Example may be embodied through a computer that is provided with a CPU, a storage device, and an interface, and through a program for controlling these hardware resources. The CPU follows a program stored in the storage device to execute the processes explained in the Example and the Another Example.

The present invention can be applied to regulators, such as temperature regulators, that are provided with data collection functions.

1: A regulator comprising:
a manipulated variable calculating portion that calculates and outputs, with each operating period, a manipulated variable MV based on a setting value SP and a process variable PV;
a trigger recording portion that records in advance a direction of change of the setting value SP that will serve as a trigger for initiating data collection;
a time limit recording portion that records in advance a time limit for terminating data collection;
an elapsed time measuring portion that measures elapsed time after commencement of data collection;
a data recording portion that records, with each operating period, the setting value SP, the process variable PV, and/or the manipulated variable MV, as data to be collected;
a data collection initiating portion that activates the data recording portion, to start data collection when a change in a setting value SP is detected, when data collection by the data recording portion is stopped, and the direction of change in the setting value SP is in the same direction as the direction of change of the setting value SP that is recorded in the trigger recording portion; and
a data collection terminating portion that terminates the data recording portion, to terminate data collection, when a change in a setting value SP is detected when data collection by the data recording portion is in progress, and the direction of change in the setting value SP is in the opposite direction from the direction of change of the setting value SP that is recorded in the trigger recording portion, or when the elapsed time after commencement of data collection has arrived at a time limit for terminating data collection, stored in the time limit recording portion.

2: The regulator as set forth in claim 1, wherein:
the data recording portion records, with each operating period, an electric current value CT, in addition to the setting value SP, the process variable PV, and/or the manipulated variable MV, as data to be recorded.

3: The regulator as set forth in claim 1, further comprising:
a time limit updating portion that updates the time limit based on an actual elapsed time after commencement of data collection.

4: The regulator as set forth in claim 3, wherein:
when the data collection has been terminated in response to a change in the temperature setting value SP, if a value of A times the time elapsed from the commencement of data collection to the termination of data collection (where A >1) is greater than the time limit that is recorded in the time limit recording portion, then the time when the updating portion sets a value that is A times the elapsed time from the commencement of data collection to the termination of data collection as a new time limit, to update the time limit that is recorded in the time limit recording portion.

5: A data collecting method comprising:
a manipulated variable calculating step for calculating and outputting, with each operating period, a manipulated variable MV based on a setting value SP and a process variable PV;
a data collection initiating step for referencing a trigger recording portion, wherein a direction of change of a setting value SP that serves as a trigger for initiating data collection is stored in advance, when a change in the setting value SP has been detected when data collection is stopped, and for activating a data recording portion, to initiate data collection, if the direction of change of the setting value SP is the same as the direction of change of the setting value SP that is stored in the trigger recording portion;
a data recording step for recording by the data recording portion, with each operating period, the setting value SP, the process variable PV, and/or the manipulated variable MV, as data to be collected;
an elapsed time measuring step for measuring elapsed time after commencement of data collection; and
a data collection terminating step for terminating the data recording portion, to terminate data collection, when a change in a setting value SP is detected when data collection by the data recording portion is in progress, and the direction of change in the setting value SP is in the opposite direction from the direction of change of the setting value SP that is recorded in the trigger recording portion, or when the elapsed time after commencement of data collection has arrived at a time limit for terminating data collection, stored in the time limit recording portion.

6: The data method as set forth in claim 5, wherein:
the data recording step includes a step for recording, with each operating period, an electric current value CT, in addition to the setting value SP, the process variable PV, and/or the manipulated variable MV, as data to be recorded.

7: The data collecting method as set forth in claim 5, further including:
a time limit updating step for updating the time limit based on an actual elapsed time after commencement of data collection.

8: The data method as set forth in claim 7, wherein:
the time limit updating step includes a step for setting a value that is A times the elapsed time from the commencement of data collection to the termination of data collection as a new time limit, to update the time limit that is recorded in the time limit recording portion if, when the data collection has been terminated in response to a change in the temperature setting value SP, a value of A times the time elapsed from the commencement of data collection to the termination of data collection (where A >1) is greater than the time limit that is recorded in the time limit recording portion.
